(19) United States
(12) Patent Application Publication
(10) Pub. No.: US 2019/0079830 A1
(43) Pub. Date: Mar. 14, 2019

(54) DATA STORAGE DEVICE AND OPERATING METHOD THEREOF

(71) Applicant: SK hynix Inc., Gyeonggi-do (KR)

(72) Inventors: Young Ho KIM, Gyeonggi-do (KR); Ki Sung KIM, Gyeonggi-do (KR); Seung Gu JI, Seoul (KR)

(21) Appl. No.: 15/958,889

(22) Filed: Apr. 20, 2018

(30) Foreign Application Priority Data
Sep. 14, 2017 (KR) 10-2017-0117538

(51) Int. Cl. G06F 11/14; G06F 12/02; G06F 9/48; G06F 3/06

(52) U.S. Cl. CPC G06F 11/1441; G06F 11/1435; G06F 12/0246; G06F 12/0253; G06F 2212/7205; G06F 9/4881; G06F 3/0619; G06F 3/0679; G06F 2212/7201; G06F 9/4818

(57) ABSTRACT

A data storage device includes a storage medium including a plurality of memory regions; and a controller suitable for completing a recovery operation due to a sudden power-off, transmitting a recovery completion signal to a host device to allow the host device to transmit an operation request, and performing a first operation based on the operation request and a valid information update operation for one or more memory regions based on priorities thereof.

### CROSS-REFERENCES TO RELATED APPLICATION

The present application claims priority under 35 U.S.C. § 119(a) to Korean application number 10-2017-0117538, filed on Sep. 14, 2017, which is incorporated herein by reference in its entirety.

### BACKGROUND

### 1. Technical Field

Various embodiments of the present disclosure generally relate to a data storage device. Particularly, the embodiments to a data storage device including a nonvolatile memory device.

### 2. Related Art

Memory systems store data provided by an external device in response to a write request. Memory systems may also provide stored data to an external device in response to a read request. Examples of external devices that use memory systems include computers, digital cameras, cellular phones, and the like. Memory systems may be embedded in an external device, or may be fabricated separately and then connected to an external device.

### SUMMARY

In an embodiment, a data storage device may include: a storage medium including a plurality of memory regions; and a controller suitable for completing a recovery operation due to a sudden power-off after power is supplied, transmitting a recovery completion signal to a host device to allow the host device to transmit an operation request, and performing a first operation based on the operation request and a valid information update operation for one or more memory regions based on priorities thereof.

In an embodiment, a method for operating a data storage device including a storage medium including a plurality of memory regions may include: completing a recovery operation due to a sudden power-off; transmitting a recovery completion signal to a host device to allow the host device to transmit an operation request; and performing a first operation based on the operation request and a valid information update operation for one or more memory regions based on priorities thereof.

In an embodiment, a data storage device may include: a storage medium including a plurality of memory regions; and a controller suitable for completing a recovery operation due to a sudden power-off, transmitting a recovery completion signal to a host device to allow the host device to transmit an operation request, and performing a valid information update operation for one or more memory regions as a background operation.

In an embodiment, a memory system may include: a storage medium; and a controller suitable for performing, after a recovery operation due to a sudden power-off, a valid information update operation of counting numbers of valid memory units included in respective memory regions of the storage medium while another operation is not to be performed.

### BRIEF DESCRIPTION OF THE DRAWINGS

The above and other features and advantages of the present invention will become more apparent to those skilled in the art to which the present invention belongs by describing various embodiments thereof with reference to the attached drawings in which:

FIG. 1 is a block diagram illustrating a data storage device in accordance with an embodiment.

FIG. 2 is a diagram illustrating a memory region and a P2L mapping data chunk of the memory region.

FIG. 3 is a diagram describing a method for determining the validity of a memory unit of FIG. 2 through P2L mapping data and L2P mapping data.

FIG. 4 is flow chart describing a method for operating a data storage device in accordance with an embodiment.

FIG. 5 is a block diagram illustrating a solid state drive (SSD) according to an embodiment.

FIG. 6 is a block diagram illustrating an application example of a data processing system including a data storage device according to an embodiment of the invention.

### DETAILED DESCRIPTION

Hereinafter, a memory system and an operating method thereof according to the present invention will be described with reference to the accompanying drawings through exemplary embodiments of the present invention. The present invention may, however, be embodied in different forms and should not be construed as being limited to the embodiments set forth herein. Rather, these embodiments are provided to describe the present invention in detail to the extent that a person skilled in the art to which the invention pertains can enforce the technical concepts of the present invention.

It is to be understood that embodiments of the present invention are not limited to the particulars shown in the drawings. The drawings are not necessarily to scale, and, in some instances, proportions may have been exaggerated in order to more clearly depict certain features of the invention. While particular terminology has been used, it is to be understood that the terminology used is for describing particular embodiments only and is not intended to limit the scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The phrase “at least one of . . . and . . . ,” when used herein with a list of items, means a single item from the list or any combination of items in the list. For example, “at least one of A, B, and C” means, only A, or only B, or only C, or any combination of A, B, and C.

As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as will be apparent to those skilled in the relevant art, an element also referred to as a feature described in connection with one embodiment may be used singly or in combination with other elements of another embodiment, unless specifically indicated otherwise.

Hereinafter, the various embodiments of the present invention will be described in detail with reference to the attached drawings.

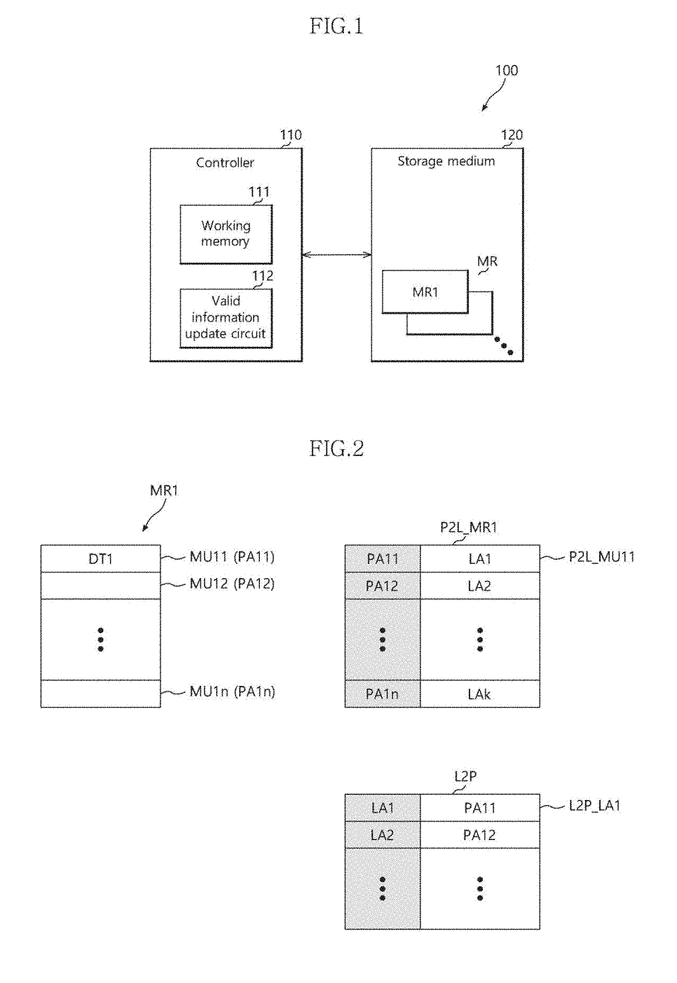

FIG. 1 is a block diagram illustrating a data storage device 100 in accordance with an embodiment of the present disclosure.

Referring to FIG. 1, the data storage device 100 may store data provided from a host device (not shown), in response to a write request from the host device. Also, the data storage device 100 may provide the stored data to the host device, in response to a read request from the host device.

The data storage device 100 may be configured by a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), a Solid State Drive (SSD), and the like.

The data storage device 100 may include a controller 110 and a storage medium 120.

The controller 110 may control general operations of the data storage device 100. The controller 110 may store data in the storage medium 120 in response to a write request transmitted from the host device, and may read data stored in the storage medium 120 and output the read data to the host device in response to a read request transmitted from the host device.

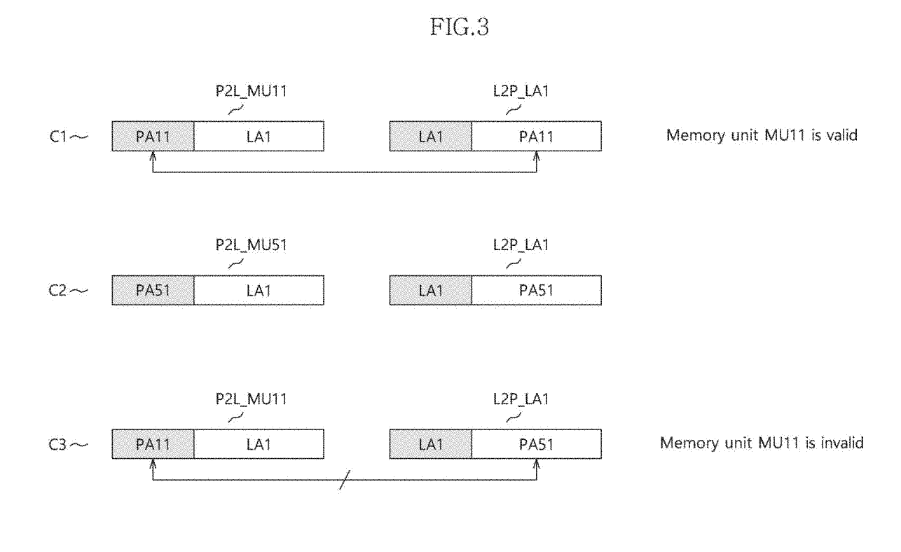

The controller 110 may include a working memory 111. The working memory 111 may store data processed by the controller 110. For example, the working memory 111 may store valid information of each of memory regions MR. The valid information of a memory region may mean the number of valid memory units included in the memory region. The controller 110 may manage the valid information of the respective memory regions MR on the working memory 111 when write-accessing the memory regions MR. The valid information of a memory region may depend on validity of memory units included in the memory region, as described below with reference to FIG. 3.

When a sudden power-off occurs, the operation of the data storage device 100 may be interrupted and abnormally ended. The controller 110 may perform a recovery operation for the sudden power-off, in a booting process after power comes back. For example, the controller 110 may recover various data stored in the working memory 111, through the recovery operation. Also, through the recovery operation, the controller 110 may prohibit the use of a memory unit of the storage medium 120 which is being write-accessed at the time of the sudden power-off or may back up data which has a possibility to be damaged due to the sudden power-off.

While the controller 110 performs the recovery operation, the host device may not transmit an operation request to the data storage device 100 and may stand by. Upon completion of the recovery operation, and the controller 110 may then transmit a recovery completion signal to the host device to allow the host device to transmit an operation request. After receiving the recovery completion signal from the controller 110, the host device may transmit an operation request, for example, such as a write request and a read request, to the controller 110. Therefore, the recovery operation needs to end quickly.

The controller 110 may further include a valid information update circuit 112. The valid information update circuit 112 may perform a valid information update operation for the memory regions MR. The valid information update circuit 112 may generate, as a valid information, the number of valid memory units included in each of the memory regions MR, through the valid information update operation.

Further, the valid information update circuit 112 may recover the valid information that is stored in the working memory 111 and have been lost due to the sudden power-off.

The valid information update circuit 112 may perform the valid information update operation as a background operation after the recovery operation is completed and the recovery completion signal is transmitted to the host device. The background operation may be an operation which is internally performed by the controller 110 without a request of the host device to improve the operation performance of the data storage device 100.

The valid information update circuit 112 may perform a request-basis operation, which is performed based on an operation request of the host device, and the valid information update operation on a priority basis.

In detail, the valid information update operation may have a lower priority than a request-basis operation. In this case, the valid information update circuit 112 may preferentially perform a request-basis operation and then perform the valid information update operation. If an operation request of the host device is transmitted while performing the valid information update operation, the valid information update circuit 112 may interrupt the valid information update operation and perform the request-basis operation. After completion of the request-basis operation, the valid information update circuit 112 may resume the interrupted valid information update operation.

According to an embodiment, besides a request-basis operation, there may be background operations that have higher priorities than the valid information update operation. The background operations that have higher priorities may include, for example, a garbage collection operation, a wear leveling operation, and a reclaim operation, but the embodiment is not limited thereto. Priorities of the valid information update operation and the other background operations may be determined based on the setting of the controller 110.

In summary, the valid information update circuit 112 may perform the valid information update operation when an operation of a higher priority than the valid information update operation is not scheduled. If an operation of a higher priority is scheduled while performing the valid information update operation, the valid information update circuit 112 may interrupt the valid information update operation and perform the operation that has a higher priority. After completion of the operation of a higher priority, the valid information update circuit 112 may resume the interrupted valid information update operation.

The valid information update circuit 112 may store a valid information recovered through the valid information update operation, in the storage medium 120.

A method describing how the valid information update circuit 112 to recovers the valid information (i.e., the number of valid memory units included in each of the memory regions MR) will be described below in detail.

The controller 110 may select one or more victim memory regions, to which a garbage collection operation is to be performed, based on the valid information of the memory regions MR included in the storage medium 120. For example, the controller 110 may select, as a victim memory region, a memory region which includes a smaller number of valid memory units than a predetermined threshold.

Further, the controller 110 may select erasable memory regions, which do not include valid memory units, based on the valid information of the memory regions MR included in the storage medium 120. For example, the controller 110 may immediately erase and reuse the selected erasable memory region.

The storage medium 120 may store data transmitted from the controller 110 and may read stored data and transmit read data to the controller 110, according to control of the controller 110. The storage medium 120 may include one or more nonvolatile memory devices.

A nonvolatile memory device may include a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

The storage medium 120 may include the memory regions MR. The memory regions MR will be described in more detail with reference to FIG. 2.

FIG. 2 is a diagram illustrating a memory region MR1 and a physical-to-logical (P2L) mapping data chunk P2L_MR1 of the memory region MR1. Each of the memory regions MR of FIG. 1 may be configured in substantially the same manner as the memory region MR1.

Referring to FIG. 2, the memory region MR1 may be, for example, a single memory block in which a nonvolatile memory device performs an erase operation. The memory region MR1 may be, for example, memory blocks which are included in a plurality of nonvolatile memory devices, respectively. The memory region MR1 may be, for example, memory blocks which are included in a plurality of nonvolatile memory devices, respectively, and are write-accessed in parallel by the controller 110.

The memory region MR1 may include a plurality of memory units MU11 to MU1n. A memory unit MU may be, for example, a unit by which a nonvolatile memory device performs a read operation. A memory unit MU may be, for example, a page.

Also, a memory unit MU may be a unit by which a physical address is allocated for a read or program operation. The memory units MU11 to MU1n may be allocated with physical addresses PA11 to PA1n, respectively. For example, the memory unit MU11 may be allocated with the physical address PA11, and the memory unit MU12 may be allocated with the physical address PA12.

The P2L mapping data chunk P2L_MR1 may include the P2L mapping data of the respective memory units MU11 to MU1n included in the memory region MR1.

In detail, each of the memory units MU11 to MU1n may correspond to its P2L mapping data. The P2L mapping data of a memory unit MU may include a logical address and a corresponding physical address of the memory unit MU, into which data is programmed or from which data is read. In the P2L mapping data of a memory unit MU, a logical address is mapped to a corresponding physical address of the memory unit MU. For example, when data DT1 that is stored in the memory unit MU11 corresponds to a logical address LA1, the P2L mapping data P2L_MU11 of the memory unit MU11 may include the logical address LA1 mapped to the physical address PA11.

The controller 110 may further manage logical-to-physical (L2P) mapping data L2P. The L2P mapping data L2P may include physical addresses mapped to logical addresses. For example, L2P mapping data L2P_LA1 of the logical address LA1 may include the physical address PA11 mapped to the logical address LA1. The L2P mapping data L2P_LA1 of the logical address LA1 may include the physical address PA11 of the memory unit MU11 in which the data DT1 corresponding to the logical address LA1 is stored.

The P2L mapping data chunk P2L_MR1 and the L2P mapping data L2P may be managed in the working memory 111. The controller 110 may generate and update the P2L mapping data chunk P2L_MR1 and the L2P mapping data L2P stored in the working memory 111, while storing data in the memory region MR1 in response to a write is request of the host device. For example, when receiving a write request for data DT1 with the logical address LA1 from the host device, the controller 110 may store the data DT1 in the memory unit MU11 which is empty, and then may generate the P2L mapping data P2L_MU11 which includes the logical address LA1 mapped to the physical address PA11 of the memory unit MU11 as well as the L2P mapping data L2P_LA1 which includes the physical address PA11 mapped to the logical address LA1.

The controller 110 may store the P2L mapping data chunk P2L_MR1 and the L2P mapping data L2P in the storage medium 120. The P2L mapping data chunk P2L_MR1 may be stored in a designated memory unit in the memory region MR1 or another memory region.

FIG. 3 is a diagram describing a method for determining the validity of the memory unit MU11 of FIG. 2 through the P2L mapping data P2L_MU11 and the L2P mapping data L2P_LA1.

Referring to FIG. 3, the controller 110 may determine whether the memory unit MU11 is valid or not by comparing the P2L mapping data P2L_MU11 to the L2P mapping data L2P_LA1. At this time, the L2P mapping data L2P_LA1 is compared to the P2L mapping data P2L_MU11 with reference to the logical address LA1. When the logical address LA1 is mapped to the physical address PA11 representing the memory unit MU11 in both of the L2P mapping data L2P_LA1 and the P2L mapping data P2L_MU11, the controller 110 may determine that the memory unit MU11 is valid, as illustrated in C1 of FIG. 3.

Thereafter, the host device may transmit a write request to store updated data for the logical address LA1. In this case, while storing the updated data in another empty memory unit MU51, the controller 110 may generate P2L mapping data P2L_MU51 of the memory unit MU51 such that the logical address LA1 is mapped to the physical address PA51 representing the memory unit MU51. Further, the controller 110 may update the L2P mapping data L2P_LA1 such that the logical address LA1 is mapped to the physical address PA51 of the memory unit MU51, as illustrated in C2 of FIG. 3.

Thereafter, when the controller 110 may determine whether the memory unit MU11 is valid or not by comparing the P2L mapping data P2L_MU11 to the L2P mapping data L2P_LA1, the controller 110 may determine the memory unit MU11 as invalid because the logical address LA1 is not mapped to the physical address PA11 representing the memory unit MU11 in the L2P mapping data L2P_LA1 due to the data update and the update of the logical address LA1 (refer to C2 in FIG. 3) while the logical address LA1 is still mapped to the physical address PA11 in the P2L mapping data P2L_MU11 of the memory unit MU11, as illustrated in C3 of FIG. 3. In other words, since the memory unit MU11 stores the data before the update of the logical address LA1, the memory unit MU11 may be determined as an invalid memory unit.

According to the descriptions made above with reference to FIG. 3, when performing the valid information update operation, the valid information update circuit 112 may determine whether the respective memory units MU11 to MU1n included in the memory region MR1 are valid or invalid. To this end, the valid information update circuit 112 may read the P2L mapping data chunk P2L_MR1 representing the memory region MR1 and related L2P mapping data stored in the storage medium 120, to the working memory 111. The related L2P mapping data may be the respective L2P mapping data of one or more logical addresses included in the P2L mapping data chunk P2L_MR1.

The valid information update circuit 112 may count the valid memory units included in a memory region. The counted number of valid memory units may be the valid information of the memory region.

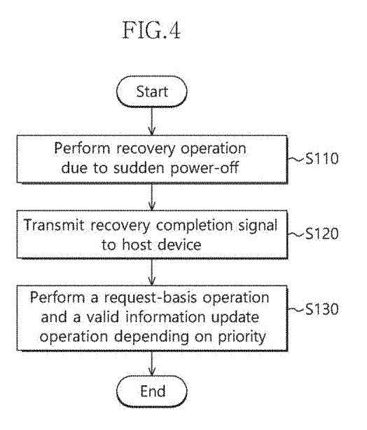

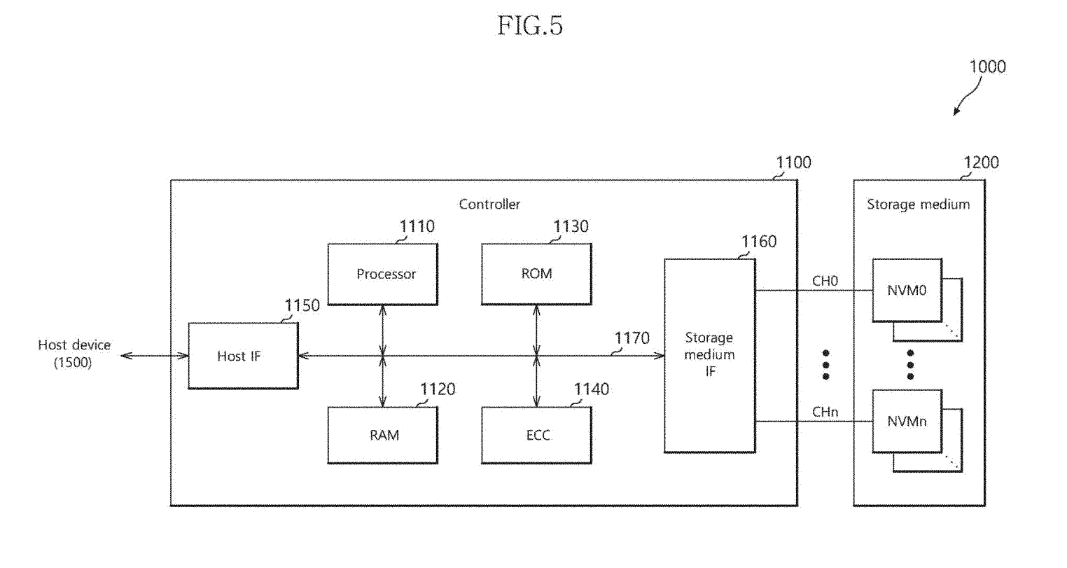

FIG. 4 is a flow chart describing a method for operating the data storage device 100 in accordance with an embodiment.

Referring to FIG. 4, at step S110, the controller 110 may perform, when it is determined that a sudden power-off has occurred, a recovery operation due to the sudden power-off.

At step S120, the controller 110 may transmit a recovery completion signal to the host device, thereby allowing the host device to transmit an operation request. Therefore, the host device may transmit an operation request to the controller 110 in response to the recovery completion signal.

At step S130, the valid information update circuit 112 may perform a request-basis operation and a valid information update operation, depending on the priorities thereof. The valid information update circuit 112 may generate the number of valid memory units included in a memory region, as the valid information of the memory region.

When the valid information update operation has a lower priority than the request-basis operation, the valid information update circuit 112 may preferentially perform the request-basis operation, and may then perform the valid information update operation. If an operation request of the host device is transmitted while performing the valid information update operation, the valid information update circuit 112 may interrupt the valid information update operation and perform the request-basis operation. After completing the request-basis operation, the valid information update circuit 112 may resume the interrupted valid information update operation.

FIG. 5 is a block diagram illustrating a solid state drive (SSD) 1000 according to an embodiment.

The SSD 1000 may include a controller 1100 and a storage medium 1200.

The controller 1100 may control data exchange between a host device 1500 and the storage medium 1200. The controller 1100 may include a processor 1110, a RAM 1120, a ROM 1130, an ECC unit 1140, a host interface 1150, and a storage medium interface 1160, operatively coupled via an internal bus 1170.

The processor 1110 may control general operations of the controller 1100. The processor 1110 may store data in the storage medium 1200 and read stored data from the storage medium 1200, according to data processing requests from the host device 1500. In order to efficiently manage the storage medium 1200, the processor 1110 may control internal operations of the SSD 1000 such as a merge operation, a wear leveling operation, and so forth.

The RAM 1120 may store programs and program data to be used by the processor 1110. The RAM 1120 may temporarily store data transmitted from the host interface 1150 before transferring them to the storage medium 1200, and may temporarily store data transmitted from the storage medium 1200 before transferring them to the host device 1500.

The ROM 1130 may store program codes to be read by the processor 1110. The program codes may include commands to be processed by the processor 1110 for the processor 1110 to control the internal units of the controller 1100.

The ECC unit 1140 may encode data to be stored in the storage medium 1200, and may decode data read from the storage medium 1200. The ECC unit 1140 may detect and correct an error occurred in data, according to an ECC algorithm.

The host interface 1150 may exchange data processing requests, data, etc. with the host device 1500.

The storage medium interface 1160 may transmit control signals and data to the storage medium 1200. The storage medium interface 1160 may be transmitted with data from the storage medium 1200. The storage medium interface 1160 may be coupled with the storage medium 1200 through a plurality of channels CH0 to CHn.

The storage medium 1200 may include a plurality of nonvolatile memory devices NVM0 to NVMn. Each of the plurality of nonvolatile memory devices NVM0 to NVMn may perform a write operation and a read operation according to the control of the controller 1100.

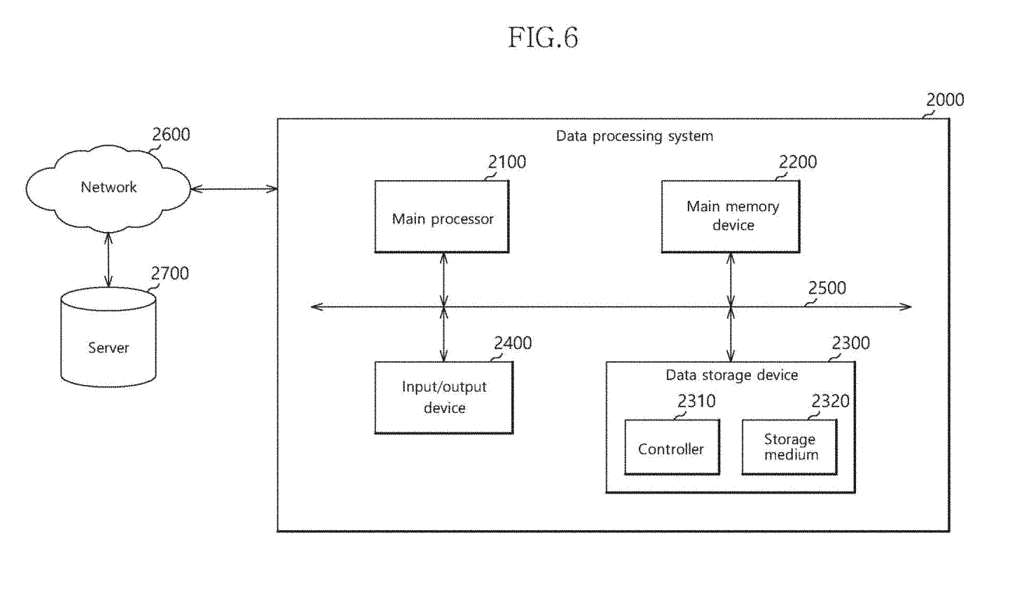

FIG. 6 is a block diagram illustrating an application example of a data processing system 2000 including a data storage device 2300 according to an embodiment of the present disclosure. Specifically, the data storage device 2300 of FIG. 6 may correspond to the data storage device 100 of FIG. 1.

The data processing system 2000 may include a computer, a laptop, a netbook, a smart phone, a digital TV, a digital camera, a navigator, etc. The data processing system 2000 may include a main processor 2100, a main memory device 2200, the data storage device 2300, and an input/output device 2400. The internal units of the data processing system 2000 may exchange data, control signals, etc. through a system bus 2500.

The main processor 2100 may control general operations of the data processing system 2000. The main processor 2100 may be, for example, a central processing unit such as a microprocessor. The main processor 2100 may execute the softwares of an operation system, an application, a device driver, and so forth, on the main memory device 2200.

The main memory device 2200 may store programs and program data to be used by the main processor 2100. The main memory device 2200 may temporarily store data to be transmitted to the data storage device 2300 and the input/output device 2400.

The data storage device 2300 may include a controller 2310 and a storage medium 2320. The data storage device 2300, the controller 2310, and the storage medium 2320 may be configured and operate in a manner substantially similar to the data storage device 100, the controller 110, and the storage medium 120 shown in FIG. 1, respectively.

The input/output device 2400 may include a keyboard, a scanner, a touch screen, a screen monitor, a printer, a mouse, or the like, capable of exchanging data with a user, such as receiving a command for controlling the data processing system 2000 from the user or providing a processed result to the user.

According to an embodiment, the data processing system 2000 may communicate with at least one server 2700 through a network 2600 such as a Local Area Network (LAN), a Wide Area Network (WAN), a wireless network, and so on. The data processing system 2000 may include a network interface (not shown) to access the network 2600.

While various embodiments have been described above, it will be understood to those skilled in the art that the embodiments described are examples only. Accordingly, the data storage device and the operating method thereof described herein should not be limited based on the described embodiments.

What is claimed is:

1. A data storage device comprising:
a storage medium including a plurality of memory regions; and
a controller suitable for completing a recovery operation due to a sudden power-off, transmitting a recovery completion signal to a host device to allow the host device to transmit an operation request, and performing a first operation based on the operation request and a valid information update operation for one or more memory regions based on priorities thereof.

2. The data storage device according to claim 1, wherein the valid information update operation has a lower priority than the first operation.

3. The data storage device according to claim 1, wherein the controller performs the valid information update operation when a second operation of a higher priority than the valid information update operation is not scheduled, and, when the second operation is scheduled while performing the valid information update operation, the controller interrupts the valid information update operation and resumes the interrupted valid information update operation after completion of the second operation.

4. The data storage device according to claim 1, wherein the controller updates the number of valid memory units among a plurality of memory units included in a memory region, as valid information of the memory region, through the valid information update operation.

5. The data storage device according to claim 1, wherein the controller recovers the valid information that is stored in a working memory of the controller that is lost due to the sudden power-off.

6. The data storage device according to claim 4, wherein the controller determines a logical address mapped to a physical address of a memory unit included in the memory region, in physical-to-logical (P2L) mapping data of the memory unit, determines a physical address mapped to the logical address in logical-to-physical (L2P) mapping data of the logical address, and determines the memory unit as a valid memory unit by comparing the physical address of the memory unit to the physical address mapped to the logical address.

7. The data storage device according to claim 1, wherein the controller selects one or more victim memory regions for which a garbage collection operation is to be performed, among the plurality of memory regions, based on valid information of each of the plurality of memory regions included in the storage medium.

8. The data storage device according to claim 1, wherein the controller performs the valid information update operation as a background operation after the recovery operation is completed and the recovery completion signal is transmitted to the host device.

9. The data storage device according to claim 7, wherein the background operation is internally performed by the controller without a request of the host device.

10. The data storage device according to claim 1, wherein the controller selects one or more erasable memory regions, among the plurality of memory regions, based on valid information of each of the plurality of memory regions included in the storage medium,
wherein the controller immediately erases and reuses the selected erasable memory region.

11. A data storage device comprising:
a storage medium including a plurality of memory regions; and
a controller suitable for completing a recovery operation due to a sudden power-off, transmitting a recovery completion signal to a host device to allow the host device to transmit an operation request, and performing a valid information update operation for one or more memory regions as a background operation.

12. The data storage device according to claim 11, wherein the controller performs the valid information update operation when a first operation of a higher priority than the valid information update operation is not scheduled, and, when the first operation is scheduled while performing the valid information update operation, the controller interrupts the valid information update operation and resumes the interrupted valid information update operation after performing the first operation.

13. The data storage device according to claim 11, wherein the controller updates the number of valid memory units among a plurality of memory units included in a memory region, as valid information of the memory region, through the valid information update operation.

14. The data storage device according to claim 13, wherein the controller determines a logical address mapped to a physical address of a memory unit included in the memory region, in P2L mapping data of the memory unit, determines a physical address mapped to the logical address in L2P mapping data of the logical address, and determines the memory unit as a valid memory unit by comparing the physical address of the memory unit to the physical address mapped to the logical address.

15. The data storage device according to claim 11, wherein the controller selects one or more victim memory regions for which a garbage collection operation is to be performed, among the plurality of memory regions, based on valid information of each of the plurality of memory regions included in the storage medium.

16. A memory system comprising:
a storage medium; and
a controller suitable for performing, after a recovery operation due to a sudden power-off, a valid information update operation of counting numbers of valid memory units included in respective memory regions of the storage medium while another operation is not to be performed.

17. The memory system of claim 16, wherein the performing of the valid information update operation includes determining a memory unit as valid or invalid by comparing physical addresses mapped to a logical address between a physical-to-logical mapping data representing the memory unit and a logical-to-physical mapping data of the logical address.

18. The memory system of claim 16, the controller is further suitable for controlling the storage medium to perform a garbage collection operation to one or more victim memory regions selected according to the numbers of valid memory units.
